(19) United States
(12) Patent Application Publication
(10) Pub. No.: US 2023/0343935 A1
(43) Pub. Date: Oct. 26, 2023

(54) PROCESSES FOR FORMING DOPED-METAL OXIDES THIN FILMS ON ELECTRODE FOR INTERPHASE CONTROL

(71) Applicant: L'Air Liquide, Soclété Anonyme pour l'Etude et l'Exploitation des Procédés Georges Claude, Paris (FR)

(72) Inventors: Sunao KAMIMURA, Yokosuka (JP); Christian DUSSARRAT, Tokyo (JP); Sanghoon KIM, Yokohama (JP)

(21) Appl. No.: 18/011,883

(22) PCT Filed: Jun. 22, 2021
(86) PCT No.: PCT/US2021/038453

§ 371 Date: Dec. 21, 2022

Related U.S. Application Data
(60) Provisional application No. 63/043,611, filed on Jun. 24, 2020.
(60) Provisional application No. 63/044,008, filed on Jun. 25, 2020.

(51) Int. Cl. H01M 4/36; H01M 4/505; H01M 4/525; H01M 4/58; H01M 4/04

(52) U.S. Cl. CPC H01M 4/366; H01M 4/505; H01M 4/525; H01M 4/5825; H01M 4/0428; H01M 2004/028

(57) ABSTRACT

This invention provides a novel solution to form an artificial interphase on the electrode to protect it from fast declining electrochemical behaviors, by depositing Doped-Metal Oxides Layer, by ALD or CVD. Metals discussed here arm IVA-VIA elements (Ti, Zr, Hf, V, Nb, Ta, Cr, Mo, W) and dopants includes her B, Al, C, Si, N, P, S, allowing the oxide network to be porous, which may be favored by the presence of the dopant. The film also needs to be thin, possibly discontinuous, and lithium ion conductive enough, so that the addition of this thin film interface allows fast lithium ion transfer at the interface between electrode and electrolyte.

### CROSS REFERENCE TO RELATED APPLICATIONS

This application claims the benefit of priority to US Provisional Patent Application Nos. 63/043,611, filed Jun. 24, 2020, and 63/044,008, filed Jun. 25, 2020, the entire contents of which are incorporated herein by reference.

### BACKGROUND OF THE INVENTION

During the first cycles of a lithium-ion battery, the formation of a solid electrolyte interface (SEI) on the anode and/or on the cathode is observed from the decomposition of the electrolyte at the electrolyte/electrode interfaces. A loss of initial capacity of the lithium-ion battery results from the consumption of lithium during the formation of this SEI. In addition, the SEI layers formed are non-uniform and unstable, not efficient to passivate electrode surfaces against degradation of the electrode active materials due to a continuous decomposition of the electrolyte. SEI layers may suffer from physical cracks during battery cycles, and lithium dendrites can appear and lead to short circuits followed by thermal runaway. Furthermore the SEI layers also create a barrier potential that makes the intercalation of lithium ions in an electrode more difficult.

In current designs, lithium ion batteries have (lithium) metal oxide, phosphate or fluoride coating (e.g. AlₓO_{y}, LiₓM_{y}PO_{z}, M=Nb, Zr, Al Ti, etc. or AlMₓF_{y} M=W, Y, etc.) at the surface of electrode and/or electrode active material, by means of wet coating, dry coating or sputtering of continuous films of metal oxide or/and phosphate in order to stabilize the interphase between electrode and electrolyte. Lithium-containing thin films are well-known for their use as surface coating layers of electrode materials in lithium-ion battery applications. Examples of lithium containing thin films include LiPON, lithium phosphate, lithium borate, lithium borophosphate, lithium niobate, lithium titanate, lithium zirconium oxides, etc. Surface coating of electrodes by ALD/CVD techniques is a preferred means to form an intended solid electrolyte interface thin film, hence avoiding the formation of these unstable layers. However, the vapor deposition of lithium-containing films is difficult to implement due to the lack of suitable lithium precursors for high volume manufacturing: most are not volatile or stable enough, they may contain undesirable impurities. Another important application of interphase thin films is in the formation of solid electrolyte materials used in solid-state batteries. Solid-state batteries are solvent-free systems with longer lifetime, faster charger time and higher energy density than conventional lithium-ion batteries. They are considered as the next technology step in battery development. By ALD/CVD techniques, uniform and conformal electrode/electrolyte interfacial thin films can even be obtained on complex architecture like 3D batteries.

Silicon anodes are also in the scope of the application of interphase thin films. Silicon is considered as the next generation of anode in lithium ion batteries development, providing higher specific capacity (3600 mAh g⁻¹) than Graphite anode (372 mAh g⁻¹) with the same potential level (0.2 V vs Li⁺/Li) as Graphite anode (0.05 V vs Li⁺/Li). The main drawback of silicon anodes is volume expansion up to 300% during charge/discharge, leading to the destabilization of SEI and physical cracks in electrodes.

The application interphase of thin films can be expanded to lithium metal anode technology. Lithium metal anodes have been considered as post lithium ion batteries (LIB) since they could provide at least 3 times more theoretical capacity compared to LIB. Lithium metal has also been highlighted owing to its high capacity (10× that of Graphite), reduced battery volume and process simplicity. However, uncontrolled lithium metal surface may lead to the growth of Li dendrite, causing a short circuit, and eventually a fire.

For next generation cathode active materials, many researches have been focused on identifying and developing metal oxide cathode materials. Among a wide range of layered oxides, Ni-rich cathode materials like NMC (lithium nickel manganese cobalt oxide) and NCA (lithium nickel cobalt aluminum oxide) are the most promising current candidates for practical applications. However, nickel-rich cathode materials tend to become amorphous when a high voltage is applied. One of the main drawbacks to these metal oxide materials, is the consecutive dissolution of the transition metals, especially nickel, due to parasite reactions of the cathode material with electrolyte. This leads to structural degradation of the cathode active material along with gas (O₂) release at electrode/electrolyte interface during battery charging. In addition, the dissolved nickel ions move to the anode side, and its deposition on anode surface provokes a rapid decomposition of SEI at the anode, finally leading to the failure of the battery.

Spinel cathode materials have been intensively investigated for their high rate capability and low or zero cobalt content. One of main issues with spinel cathode materials such as LMO (lithium manganese oxide), LNMO (lithium nickel manganese oxide) is the dissolution of manganese divalent ions (2 Mn³⁺→Mn⁴⁺+Mn²⁺) during battery charge process, which mostly occurs at electrode/electrolyte interface, then re-deposition on anode side and destruction of its SEI as through the same mechanism of Ni-rich cathode materials.

To address the interface issues between electrolyte and cathode electrodes such as transition metal dissolution, excessive electrolyte decomposition, thin film deposition on cathodes and/or cathode materials can be applied. For example, U.S. Pat. No. 8,535,832B2 discloses wet coating of metal oxide (Al₂O₃, Bi₂O₃, B₂O₃, ZrO₂, MgO, Cr₂O₃, MgAl₂O₄, Ga₂O₃, SiO₂, SnO₂, CaO, SrO, BaO, TiO₂, Fe₂O₃, MoO₃, MoO₂, CeO₂, La₂O₃, ZnO, LiAlO₂ or combinations thereof) onto a cathode active material comprising Ni, Mn and Co. U.S. Pat. No. 9,543,581B2 describes dry coating of amorphous Al₂O₃ on precursor particles of cathode active materials comprising Ni, Mn and Co elements. U.S. Pat. No. 9,614,224B2 describes a LiₓPO_{y}Mn_{z} coating using sputtering method on cathode active materials comprising Mn. U.S. Pat. No. 9,837,665B2 describes lithium phosphorus oxynitride (LiPON) thin films coating using sputtering method on cathode active materials comprising Li, Mn, Ni, and oxygen containing compound with a dopant of at least one of Ti, Fe, Ni, V, Cr, Cu, and Co. U.S. Pat. No. 9,196,901B2 describes Al₂O₃ thin films coating using an atomic layer deposition (ALD) method on cathode laminates and cathode active materials comprising Co, Mn, V, Fe, Si, or Sn and being an oxide, phosphate, silicate or a mixture of two or more thereof. U.S. Ser. No. 10/224,540B2 describes Al₂O₃ thin film coating using ALD method on a porous silicon anode. U.S. Ser. No. 10/177,365B2 describes AlWₓF_{y} or AlWₓF_{y}C_{z} thin film coating onto cathode active materials comprising LiCoO₂ using ALD. U.S. Pat. No. 9,531,004B2 describes hybrid thin films coating comprising the first layer of Al₂O₃, TiO₂, SnO₂, V₂O₅, HfO₂, ZrO₂, ZnO, and the second layer of fluoride-based coating, a carbide-based coating, and a nitride-based coating using ALD method on anode materials group consisting of: lithium titanate Li₍₄₊ₓ₎Ti₅O₁₂, where 0≤x≤3 (LTO), graphite, silicon, silicon-containing alloys, tin-containing alloys, and combinations thereof.

### BRIEF SUMMARY OF THE INVENTION

The invention provides the following solutions to form an artificial interphase on an electrode to protect it from fast declining electrochemical behaviors, by depositing Doped-Metal Oxides Layers onto the cathode or cathode active materials by ALD or CVD. These Doped-Metal Oxides Layers reduce excessive decomposition of electrolyte at the electrode/electrolyte interfaces during SEI formation, reducing capacity loss at the first cycles. The presence of such a Doped-Metal Oxides Layer also reduces the cathode active materials' transition metal cation dissolution, which is caused by parasite reactions between electrolyte and cathode active materials, then its re-deposition, on the anode. Electrochemical activity of the battery is thereby improved. As discussed above, other types of films have been proposed, especially pure metal oxides such as Al₂O₃. However this type of material behaves as an ion-insulator, and therefore does not allow the best electrochemical performance of the resulting cathode and battery. The composition of the Doped-Metal Oxides Layers takes into account the need of the Li ion diffusion, through the choice of transition metals that can undergo a change of oxidation state. The corresponding metal oxide is deposited with separate dopant chemicals and/or using vapor phase metal precursors that contain dopents such as C, Si, Sn, B, Al, N, P, and/or S. The deposition conditions are selected to produce the Doped-Metal Oxides film rather than a metal oxide film. While not wishing to be bound by any specific theory, the Doped-Metal Oxides films would in most circumstances be considered “low quality” films not suitable for most applications. For example, such materials are generally low density due to porosity caused by the dopant elements (especially Carbon and Phosphorus). However it may be such porosity that facilitates a balance between protecting the cathode and allowing Li ion movement. It is also possible that adding first row transition elements, preferably Mn, Ni, Co, Fe, Cu, may increase the films' ion conductivity and thereby improve the electrochemical performance.

The invention may be further understood in relation to the following non-limiting, exemplary embodiments described as enumerated sentences:
1. A cathode or a cathode active material comprising at least a partial surface coating of a doped metal oxide film, preferably the metal is selected from Niobium, Tantalum, Vanadium, Zirconium, Titanium, Hafnium, Tungsten, Molybdenum, Chromium and combinations thereof.
2. The cathode or a cathode active material of SENTENCE 1, wherein the doped metal oxide film is either a metal, oxygen and carbon-containing film or a metal, oxygen and phosphorus containing film.
3. The cathode or a cathode active material of SENTENCE 1, wherein the doped metal oxide film is a doped Niobium oxide film.
4. The cathode or a cathode active material of SENTENCE 1, wherein the doped metal oxide film is a Niobium, oxygen and carbon-containing film or a Niobium, oxygen and phosphorus containing film.
5. The cathode or a cathode active material of any of SENTENCEs 1-4, wherein the cathode or a cathode active material is only partially coated with the doped metal oxide film.
6. The cathode or a cathode active material of claim any of SENTENCEs 1-5, wherein the doped metal oxide film has an average thickness of 0.02 nm to 10 nm, preferably 0.1 nm to 5 nm, most preferably 0.2 to 2 nm.
7. The cathode or a cathode active material of any of SENTENCEs 1-4, wherein the doped metal oxide film has an atomic percentage for carbon atoms from 5% to 50%, preferably 10% to 30%, most preferably 15 to 25%.
8. The cathode or a cathode active material of claim any of SENTENCEs 3-7, wherein the doped metal oxide film has a refractive index of 1.5 to 2.5, preferably 1.6 to 2.1, most preferably 1.7 to 2.0.
9. The cathode or a cathode active material of SENTENCE 1, wherein the doped metal oxide has an average atomic composition of MxO_{y}D_{z}, wherein M is a transition metal or a II-A to VI-B element, O is oxygen, and D is a dopant atom other than lithium, M or O, preferably D is selected from C, Si, Sn, B, Al, N, P, or S, and wherein x=10 to 60%, y ranges from 10 to 60%, and z ranges from 5 to 50%, preferably from 10 to 30%.
10. The cathode or a cathode active material of SENTENCE 9, wherein the cathode or a cathode active material is only partially coated with the doped metal oxide film.
11. The cathode or a cathode active material of SENTENCE 9 or 10, wherein the doped metal oxide film has an average thickness of 0.02 nm to 10 nm, preferably 0.1 nm to 5 nm, most preferably 0.2 to 2 nm.
12. The cathode or a cathode active material of any of SENTENCEs 9-11, wherein the doped metal oxide film has an atomic percentage for carbon atoms from 5% to 50%, preferably 10% to 30%, most preferably 15 to 25%.
13. The cathode or a cathode active material of claim any of SENTENCEs 9-12, wherein the doped metal oxide film has a refractive index of 1.5 to 2.5, preferably 1.6 to 2.1, most preferably 1.7 to 2.0
14. A proton exchange membrane battery comprising a cathode or cathode active material according to any of SENTENCEs 1-13.
15. A method of coating a cathode or a cathode active material with a doped metal oxide film, the method comprising the steps of:
   a1 exposing the cathode or cathode active material to a chemical precursor vapor, and
   b1. depositing the doped metal oxide film on the cathode or cathode active material.
16. The method of SENTENCE 15, further comprising a step a2. of exposing the cathode or cathode active material to a co-reactant.
17. The method of SENTENCE 16, wherein the step a1. of exposing the cathode or cathode active material to a chemical precursor vapor and the step a2. of exposing the cathode or cathode active material to a co-reactant, are sequentially performed.
18. The method of SENTENCE 17, further comprising a step a1i. of purging the chemical precursor vapor prior to step a2. of exposing the cathode or cathode active material to a co-reactant.
19. The method of SENTENCE 18, wherein the step b1. depositing the doped metal oxide film on the cathode or cathode active material comprises an atomic layer deposition step.
20. The method of SENTENCE 18, wherein the step b1. of depositing the doped metal oxide film on the cathode or cathode active material comprises a chemical vapor deposition step.
21. The method of SENTENCEs 15-20, wherein the co-reactant is an oxygen source such as O2, O3, H2O, H2O2, NO, NO2, N2O or a NOx; an oxygen-containing silicon precursor, an oxygen-containing tin precursor, a phosphate such as trimethylphosphate, diethyl phosphoramidate, or a sulfate.
22. The method of any of SENTENCEs 15-19, wherein the doped metal oxide film produced by step b1. has an average atomic composition of MₓO_{y}D_{z}, wherein M is a transition metal or a II-A to VI-B element, preferably M is selected from Niobium, Tantalum, Vanadium, Tungsten, Molybdenum, Chromium, Hafnium, Zirconium, Titanium, and combinations thereof, O is oxygen, and D is a dopant atom other than lithium, M or O, preferably D is selected from C, Si, Sn, B, Al, N, P, or S, and wherein x=0.1-0.3, y=0.3-0.65 and z=0.1-0.3.
23. The method of any of SENTENCEs 15-22, wherein one or more of steps are repeated.
24. The method of any of SENTENCEs 15-23, wherein a temperature of the chemical precursor vapor and/or the cathode or cathode active material is 200 degrees C. or less, preferably 50 degrees C. to 200 degrees C., more preferably 100 degrees C. to 200 degrees C., even more preferably 100 degrees C. to 150 degrees C.
25. The method of any of SENTENCEs 15-24, wherein the cathode active material, or the cathode active material in the cathode, is selected from the group consisting of a) layered oxides such as Ni-rich cathode materials like NMC (lithium nickel manganese cobalt oxide) and NCA (lithium nickel cobalt aluminum oxide); b) spinel cathode materials such as LMO (lithium manganese oxide), LNMO (lithium nickel manganese oxide); c) Olivine structured cathode materials, in particular the family of Olivine phosphates such as LCP (lithium cobalt phosphate), LNP (lithium nickel phosphate); and combinations thereof.

### BRIEF DESCRIPTION OF THE SEVERAL VIEWS OF THE DRAWING

For a further understanding of the nature and objects for the present invention, reference should be made to the following detailed description, taken in conjunction with the accompanying drawings, in which like elements are given the same or analogous reference numbers and wherein:

FIG. 1 shows the long term cycling performance at 1 C (first 3 pre-cycles at 0.2 C) for NbOC thin films deposition on NMC622 powder using NbCp(=NtBu)(NMe₂)₂ (“Nab”)/H₂O using a Powder ALD (PALD) reactor;

FIG. 2 shows a normalized long term cycling performance for NbOC thin films deposition on NMC622 powder using NbCp(=NtBu)(NMe₂)₂ (“Nab”)/H₂O, using a Powder ALD (PALD) reactor; (normalization to their original discharge capacity at 1 C);

FIG. 3 shows the C-Rate performance for NbOC thin films deposition on NMC622 powder using NbCp(=NtBu)(NMe₂)₂ (“Nab”)/H₂O using a Powder ALD (PALD) reactor;

FIG. 4 shows a normalized C-rate performance for NbOC thin films deposition on NMC622 powder using NbCp(=NtBu)(NMe₂)₂ (“Nab”)/H₂O using a Powder ALD (PALD) reactor (normalization to their original discharge capacity at 0.2 C);

FIG. 5 shows SEM images for pristine and NbOC formed using NbCp(=NtBu)(NMe₂)₂ (“Nab”)/H₂O by Powder ALD (PALD)-100 C-20Cy before and after battery cycling;

FIG. 6 shows long term cycling performance at 1 C (first 3 pre-cycles at 0.2 C) for NbOC thin films deposition on a NMC622 Electrode in ALD regime (EALD) using NbCp(=NtBu)(NMe₂)₂ (“Nab”)/H₂O;

FIG. 7 shows the normalized long term cycling performance for NbOC thin films deposition on a NMC622 Electrode in ALD regime (EALD) using NbCp(=NtBu)(NMe₂)₂ (“Nab”)/H₂O (normalization to their original discharge capacity at 1 C);

FIG. 8 shows the C-Rate performance for NbOC thin films on NMC622 electrodes using NbCp(=NtBu)(NMe₂)₂ (“Nab”)/H₂O;

FIG. 9 shows the normalized C-rate performance for NbOC thin films on NMC622 Electrode in ALD regime (EALD) using NbCp(=NtBu)(NMe₂)₂ (“Nab”)/H₂O (normalization to their original discharge capacity at 0.2 C);

FIG. 10 shows the long term cycling performance at 1 C (first 3 pre-cycles at 0.2 C) for NbOCP thin films on NMC622 Electrode in CVD regime (ECVD) using Nb(═NtBu)(NMe₂)₂(OEt)(“Nau”), TMPO and O₃;

FIG. 11 shows the normalized long term cycling performance for NbOCP thin films on NMC622 Electrode in CVD regime (ECVD) using Nb(═NtBu)(NMe₂)₂(OEt) (“Nau”)/TMPO/O₃ (normalization to their original discharge capacity at 1 C);

FIG. 12 shows the C-Rate performance for NbOCP thin films deposition on a NMC622 Electrode in CVD regime (ECVD) using Nb(═NtBu)(NMe₂)₂(OEt) (“Nau”)/TMPO/O₃;

FIG. 13 shows the normalized C-rate performance for NbOCP thin films deposition on NMC622 Electrode in CVD regime (ECVD) using Nb(═NtBu)(NMe₂)₂(OEt) (“Nau”)/TMPO/O₃ (normalization to their original discharge capacity at 0.2 C);

FIG. 14 shows the long term cycling performance at 1 C (first 3 pre-cycles at 0.2 C) for ZrOC thin films on LNMO electrode in ALD regime using “ZrCp” e.g. ZrCp(NMe₂)₃/O₃;

FIG. 15 shows the normalized long term cycling performance for ZrOC thin films on LNMO electrode in ALD regime using “ZrCp” e.g. ZrCp(NMe₂)₃/O₃ (normalization to their original discharge capacity at 1 C);

FIG. 16 shows the C-Rate performance for ZrOC thin films on LNMO electrode using “ZrCp” e.g. ZrCp(NMe₂)₃/O₃;

FIG. 17 shows the normalized C-rate performance for ZrOC thin films on LNMO electrode in ALD regime using ZrCp(NMe₂)₃/O₃ (normalization to their original discharge capacity at 0.2 C).

### DETAILED DESCRIPTION OF THE INVENTION

The disclosure provides solutions to form an interphase on an electrode to protect it from fast declining electrochemical behaviors. The electrode interphase is formed on the cathode active material prior to or after its incorporation into a final cathode. The Doped-Metal Oxides Layers are formed by Chemical Vapor Deposition (CVD) or Atomic Layer Deposition (ALD) using volatile precursor(s) supplied simultaneously, sequentially and/or by pulses of the vapor phase of the precursor.

“Doped-Metal Oxides” and “Doped-Metal Oxide films” as used herein means a transition metal oxide film having one or more additional elements such that the atomic ratio is MxOyDz, wherein M=the aggregate portion of transition metal(s), O is Oxygen, and D is the aggregate portion of other elements doping the film, such as Carbon and Phosphorus. Generally, x ranges from 10 to 60%, y ranges from 10 to 60%, and z ranges from 5 to 50%, preferably from 10 to 30%.

Preferably M is a transition metal that forms one or more stable ions which have incompletely filled d orbitals. In particular, M may be one or more of Ti, Zr, Hf, V, Nb, Ta, Cr, Mo, or W.

Preferably at least one D is selected from C, Si, Sn, B, N, P, or S, more preferably Carbon and/or Phosphorus. Other possible D's may include Al, Mn, Co, Fe, and Cu. Particular preferred Doped-Metal Oxides Layers include C-containing titanium oxides, Si-containing titanium oxides, P-doped titanium oxides, C-containing zirconium oxides, Si-containing zirconium oxides, P-doped zirconium oxides, C-containing niobium oxides, Si-containing niobium oxides, P-doped niobium oxides.

The Doped-Metal Oxides films are formed by a CVD or ALD process to deposit the Doped-Metal Oxides Layer onto the cathode active material prior to, at an intermediate manufacturing step of the final cathode, or after its incorporation into a final cathode. The Doped-Metal Oxides films may be continuous films entirely coating the cathode active material such as by a powder ALD of a powder cathode active material prior to inclusion in the cathode. The films may be discontinuous, either by controlled deposition conditions to limit film growth or as a result of the cathode active material being incorporated in the cathode such that only part of its surface is exposed to the CVD or ALD deposition process. Generally the Doped-Metal Oxides films have an average thickness of 0.125 to 10 nm, such as 0.125 nm to 1.25 nm, preferably 0.3 nm to 4 nm.

The Doped Metal Oxides deposits may be deposited on an electrode such as those composed of:
a layer structured oxide, preferably a “NMC” (a lithium nickel manganese cobalt oxide), a NCA (a lithium nickel cobalt aluminum oxide) or a LNO (a lithium nickel oxide);
a spinel, preferably a LNMO (a lithium nickel manganese oxide) or a LMO (a lithium manganese oxide);
an olivine (lithium metal phosphate, with metal may be iron, cobalt, manganese);
a form of carbon anode, such as graphite, doped or not;
a silicon anode,
a tin anode,
a silicon-tin anode, or
lithium metal.

The deposition may be done on an electrode active material powder, on electrode active material porous materials, on different shapes of electrode active materials, or in pre-formed electrodes in which the electrode active material may be already associated with conductive carbons and/or binders and may already be supported by a current collector foil.

“Cathode” in lithium ion batteries refers to the positive electrode in an electrochemical cell (battery) where the reduction of cathode materials takes place by insertion of electrons and lithium ions during charge. During discharge, cathode materials are oxidized by releasing electrons and lithium ions. Lithium ions move from cathode to anode or vice versa within an electrochemical cell through electrolyte, while electrons are transferred through an external circuit. Cathode is generally composed of cathode active material (i.e. lithiated metal layered oxide) and conductive carbon black agent (acetylene black Super C65, Super P) and binder (PVDF, CMC).

“Cathode active materials” are the main elements in the composition of cathode (positive electrode) for battery cells. The cathode materials are, for example, cobalt, nickel and manganese in the crystal structure such as the layered structure, forms a multi-metal oxide material in which lithium is inserted. The examples of cathode active materials are layered lithium nickel manganese cobalt oxide (LiNixMnyCozO2), spinel lithium manganese oxide (LMn2O4) and olivine lithium iron phosphate (LiFePO4).

The Doped-Metal Oxides films are formed by a CVD or ALD process using the vapor(s) of one or more chemical precursors that contribute to the final film formation. Any suitable precursor(s) may be selected for use based on their known applicability to the formation of Metal Oxides or even Doped-Metal Oxides used for other applications. Generally precursors known for Metal Oxides will be used in distinctive CVD or ALD process parameters that produce the Doped-Metal Oxides. Such parameters include lower vapor and/or substrate temperatures compared to the Metal Oxide depositions to, for example, deliberately produce a “low quality” film having more than a 1% carbon content, a relatively low low refractive index compared to the Metal Oxide, and/or a higher level of porosity (and thus lower density) compared to the corresponding Metal Oxide.

A wide variety of precursors may be suitably used, under optimized deposition conditions, to form Doped-Metal Oxides.

The Preferred IVA metal precursors are:
M(OR)₄ with each R is independently a C1-C6 carbon chain (linear or branched), most preferably M(OMe)₄, M(OiPr)₄, M(OtBu)₄, M(OsBu)₄
M(NR¹R²)₄ with each R¹ and R² are independently a C1-C6 carbon chain (linear or branched), most preferably M(NMe₂)₄, M(NMeEt)₄, M(NEt₂)₄
ML(NR¹R²)₃ with L represents an unsubstituted or substituted allyl. cyclopentadienyl, pentadienyl, hexadienyl, cyclohexadienyl, cycloheptadienyl, cyclooctadienyl and each R¹ and R² are independently a C1-C6 carbon chain (linear or branched), most preferably MCp(NMe₂)₃, M(MeCp)(NMe₂)₃, M(EtCp)(NEt₂)₃, MCp*(NMe₂)₃, MCp(NMe₂)₃, M(MeCp)(NMe₂)₃, M(EtCp)(NEt₂)₃, MCp*(NMe₂)₃, M(iPrCp)(NMe₂)₃, M(sBuCp)(NMe₂)₃, M(tBuCp)(NMe₂)₃, N(secPenCp)(NMe₂)₃, M(nPrCp)(NMe₂)₃
ML(OR)₃ with L represents an unsubstituted or substituted allyl. cyclopentadienyl, pentadienyl, hexadienyl, cyclohexadienyl, cycloheptadienyl, cyclooctadienyl and each R is independently a C1-C6 carbon chain (linear or branched), most preferably MCp(OiPr)₃, M(MeCp)(OiPr)₃, M(EtCp)(OEt)₃, MCp*(OEt)₃, M(iPrCp)(NMe₂)₃, M(sBuCp)(NMe₂)₃, M(tBuCp)(NMe₂)₃, N(secPenCp)(NMe,)₃, M(nPrCp)(NMe₂)₃
   Preferred VA metal precursors are:
M(OR)₅ with each R is independently a C1-C6 carbon chain (linear or branched), most preferably M(OEt)5, M(OiPr)5, M(OtBu)5, M(OsBu)5
M(NR¹R²)₅ with each R¹ and R² are independently a C1-C6 carbon chain (linear or branched), most preferably M(NMe₂)₅, M(NMeEt)₅, M(NEt₂)₅
ML(NR¹R²)ₓ with x=3 or 4, L represents an unsubstituted or substituted allyl, cyclopentadienyl, pentadienyl, hexadienyl, cyclohexadienyl, cycloheptadienyl, cyclooctadienyl or a imide of the form N—R and each R¹ and R² are independently a C1-C6 carbon chain (linear or branched), most preferably MCp(NMe₂)₃, M(MeCp)(NMe₂)₃, M(EtCp)(NEt₂)₃, MCp*(NMe₂)₃ M(=NtBu)(NMe₂)₃, M(=NtAm)(NMe₂)₃, M(=NtBu)(NEt₂)₃, M(=NtBu)(NEtMe)₃, M(=NiPr)(NEtMe)₃.
M(=NR¹)L(NR²R³)ₓ with x=1 or 2, L represents an unsubstituted or substituted allyl, cyclopentadienyl, pentadienyl, hexadienyl, cyclohexadienyl, cycloheptadienyl, cyclooctadienyl and each R¹ and R² and R³ are independently a C1-C6 carbon chain, most preferably MCp(=NtBu)(NMe₂)₂, M(MeCp)(N=tBu)(NMe₂)₂, M(EtCp)(N=tBu)(NMe₂)₂, MCp*(=NtBu)(NMe₂)₂, MCp(=NtBu)(NEtMe)₂, M(MeCp)(N=tBu)(NEtMe)₂, M(EtCp)(N=tBu)(NEtMe)₂.
ML(OR)ₓ with x=3 or 4, L represents an unsubstituted or substituted allyl, cyclopentadienyl, pentadienyl, hexadienyl, cyclohexadienyl, cycloheptadienyl, cyclooctadienyl or a imide of the form N—R, with each R is independently a C1-C6 carbon chain (linear or branched), most preferably MCp(OiPr)₃, M(MeCp)(OiPr)₃, M(EtCp)(OEt)₃, MCp*(OEt)₃ M(=NtBu)(OiPr)₃, M(=NtAm)(OiPr)₃,
ML(OR)ₓ(NR¹R²)_{y} with x and y independently equal to 1 or 2, L represents an unsubstituted or substituted allyl, cyclopentadienyl, pentadienyl, hexadienyl, cylohexadienyl, cycloheptadienyl, cyclooctadienyl or a imide of the form N—R, with each R is independently a C1-C6 carbon chain (linear or branched), most preferably MCp(OiPr)₂(NMe₂), M(MeCp)(OiPr)₂(NMe₂), M(EtCp)(OEt)₂(NMe₂), M(=NtBu)(OiPr)₂(NMe₂), M(=NtBu)(OiPr)(NMe₂)₂, M(=NtBu)(OiPr)₂(NMe₂), M(=NtBu)(OiPr)₂(NEtMe), M(=NtBu)(OiPr)₂(NEt₂), M(=NtBu)(OEt)₂(NMe₂), M(=NtBu)(OEt)₂(NEtMe), M(=NtBu)(OEt)₂(NEt₂), M(=NiPr)(OiPr)₂(NMe₂), M(=NiPr)(OiPr)₂(NMe₂)₂, M(=NiPr)(OiPr)₂(NEtMe), M(=NiPr)(OiPr)₂(NEt₂), M(=NiPr)(OEt)₂(NMe₂), M(=NiPr)(OEt)₂(NEtMe), or M(=NiPr)(OEt)₂(NEt₂).
   Preferred VIA metal precursors are:
M(OR)₆ with each R is independently a C1-C6 carbon chain (linear or branched), most preferably M(OEt)₅, M(OiPr)₅, M(OtBu)₅, M(OsBu)₅
M(NR¹R²)₆ with each R¹ and R² are independently a C1-C6 carbon chain (linear or branched), most preferably M(NMe₂)₆, M(NMeEt)₆, M(NEt₂)₆
M(NR¹R²)ₓL_{y} with x and y being independently equal to 1 to 4, L represents an unsubstituted or substituted allyl, cyclopentadienyl, pentadienyl, hexadienyl, cyclohexadienyl, cycloheptadienyl, cyclooctadienyl or a imide of the form N—R and each R¹ and R² are independently a C1-C6 carbon chain (linear or branched), most preferably MCp(NMe₂)₃, M(MeCp)(NMe₂)₃, M(EtCp)(NEt₂)₃, MCp*(NMe₂)₃M(=NtBu)₂(NMe₂)₂, M(=NtAm)₂(NMe₂)₂, M(=NtBu)(NEt₂)₂
M(OR)ₓ(NR¹R²)_{y}L_{z} ML with x, y and z being independently equal to 0 to 4, L represents an unsubstituted or substituted allyl, cyclopentadienyl, pentadienyl, hexadienyl, cyclohexadienyl, cycloheptadienyl, cyclooctadienyl or a imide of the form N—R, with each R is independently a C1-C6 carbon chain (linear or branched), most preferably MCp(OiPr)₃, M(MeCp)(OiPr)₃, M(EtCp)(OEt)₃, M(=NtBu)₂(OiPr)₂, M(=NtAm)₂(OiPr)₂, M(=NtBu)₂(OtBu)₂, M(=NiPr)₂(OtBu)₂, M(=NtBu)₂(OiPr)₂, M(=NiPr)₂(OiPr)₂.
M(=O)xLy, with x, y and z being independently equal to 0 to 4, L represents an unsubstituted or substituted allyl, cyclopentadienyl, pentadienyl, hexadienyl, cyclohexadienyl, cycloheptadienyl, cyclooctadienyl, amide or a imide of the form N—R, with each R is independently a C1-C6 carbon chain (linear or branched), most preferably M(=O)₂(OtBu)₂, M(=O)₂(OiPr)₂, M(=O)₂(OsecBu)₂, M(=O)₂(OsecPen)₂, M(=O)₂(NMe₂)₂, M(=O)₂(NEt₂)₂, M(=O)₂(NiPr₂)₂, M(=O)₂(NnPr₂)₂, M(=O)₂(NEtMe)₂, M(=O)₂(NPen₂)₂.

The Doped-Metal Oxides films may be formed using a single precursor or a combination of two or more precursors, in either case optionally with an oxidizing co-reactant (if needed or desired). A single precursor may contribute all elements found in the final film including the oxygen and the dopant element(s) D. Alternatively, the Metal may come from one precursor, the Oxygen from an oxidizing co-reactant, and the dopant D element(s) from a second precursor. For example, a Metal precursor listed above may be combined with a second precursor that contributes or increases the amount of the dopant element(s) D, one or both of which are deposited in an oxidizing environment that produces some Metal Oxides in the final film. In other cases, a second precursor supplies the Dopant D and oxidizes the Metal to produce metal oxides in the final film. One of skill in the art is able to select the appropriate precursor(s) and co-reactants from those known in the art to produce the Doped-Metal Oxides films with the desired composition when used under optimized deposition conditions to “tune” the levels of metal oxides and dopant(s) D. Exemplary guidance on various precursor options include:
Oxygen may come from an O-source such as O2, O3, H2O, H2O2, NO, NO2, N2O or a NOx
Oxygen may come from a dopant source such as an oxygen-containing silicon precursor, as an oxygen-containing tin precursor, a phosphate such as trimethylphosphate, diethyl phosphoramidate, or a sulfate.
Nitrogen may come from a N-source such as N2, NH3, N2H4, N2H4-containing mixtures, an alkyl hydrazine, NO, NO2, N2O or a NOx
Nitrogen may come from a dopant source such as an nitrogen-containing silicon precursor, as an nitrogen-containing tin precursor, or a phosphate such as diethyl phosphoramidate.
Carbon may come from a C-source such as an hydrocarbon, carbon-containing silicon precursor, a carbon-containing tin precursor, a carbon-containing boron precursor, a carbon containing aluminum precursor, a carbon-containing phosphorus precursor, a phosphate such as trimethylphosphate, diethyl phosphoramidate, or a sulfate.
Silicon may come from a Si-source such as a silane or a silicon-containing organometallic precursor.
Tin may come from a Sn-source such as a stannane or a tin-containing organometallic precursor.
Aluminum may come from an Al-source such as an alane, including alkyl alanes, or an aluminum-containing organometallic precursor.
Phosphorus may come from a phosphine, including an organic phosphine or a phosphate such as trimethylphosphate or diethyl phosphoramidate.
Sulfur may come from a S-source such as a sulfur, S8, H2S, H2S2, SO2, an organic sulfite, a sulphate, or a sulfur-containing organometallic precursor.
The first row transition metals may come from known organometallics or other precursors suitable for use in vapor deposition.

### EXAMPLES

### Examples 1-5: Deposition and Electrochemical Performances of NbOC Thin Films Deposited on NMC622 Powder at 100 and 150° C.

### Experimental Conditions for Deposit/Film Formation:

Depositions were performed on NMC622 powder using a fluidized bed reactor in the following experimental conditions:
Reactor temperature x° C.
Reactor Pressure: 1 torr
Precursor canister T: 115° C.
Precursor canister P: 50 torr
Number of cycles: y

### Pulse Sequence:

Nb precursor: 30 s
Purge: 20 s
H₂O: 5 s
Purge: 5 s

The Nb precursor in these examples 1-5 is NbCp(=NtBu)(NMe₂)₂ (“NAB”). The number of cycles on NMC622 electrodes or NMC powder are typically limited to 5-20 ALD cycles, corresponding to about 1.5 to 4 ångström, a thickness insufficient to perform film composition. Such characterizations were therefore performed on films deposited after 300 ALD cycles. The corresponding thickness and film composition are:
process temperature: 150° C.⇒GPC˜0.27 Å. Nb: ˜24%, O˜47%, C˜27%, N<DL
process temperature: 100° C.⇒GPC˜0.78 Å. Nb: ˜25%, O˜48%, C˜27%, N<DL

The refractive index of these films is about 1.7 vs. 2.25 for Nb₂O₅ thin films at 200° C. and above.

### Electrochemical Characterizations:

Experimental Conditions:
Cathode material NMC622
The test electrode is composed of 88:7:5 wt % of active cathode material:carbon black (C65):PVDF (Solef 5130), which is then casted on Al current corrector using a doctor blade (200 micron).
Five or twenty NbCp(=NtBu)(NMe2)2/H₂O ALD cycles at process temperatures provided in the graph
Electrolyte: 1M LiPFe in EC:EMC(1:1 wt)
Use of Li metal as anode material
Electrode loading of ˜5 mg/cm², 40 micron thick
1 C=180 mA g⁻¹, battery cycled between 3.0 and 4.3 V (vs Li⁺/Li)

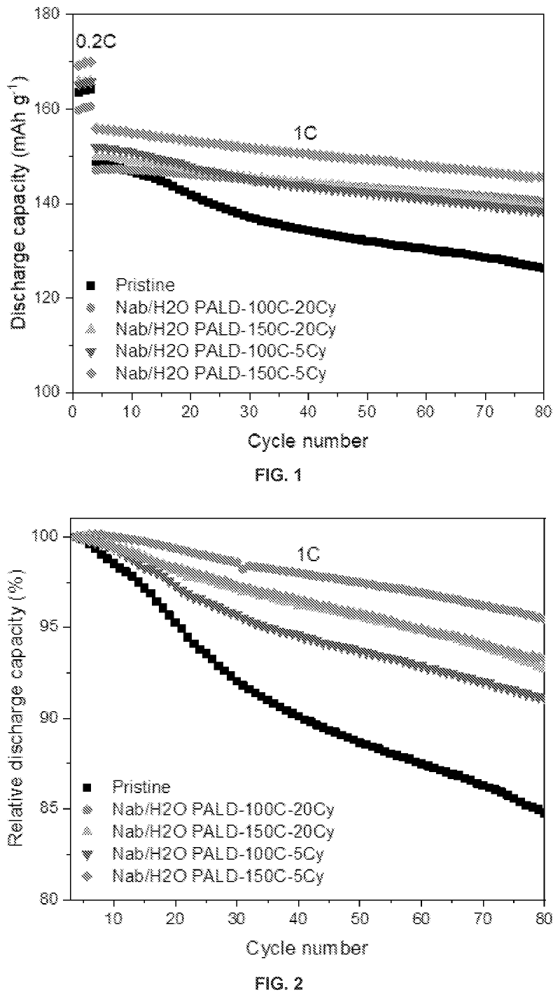

As seen in FIG. 1, NbOC powder coated NMC622 electrodes, especially for less ALD cycled samples (NbCp(=NtBu)(NMe2)2/H2O Powder ALD-100 C-5Cy) shows higher initial capacity at 0.2 C compared to pristine NMC622 electrode. When ALD is performed for 20 cycles, the initial capacity becomes very close to that of pristine, presumably due to the thicker NbOC film. The long term stability at 1 C for subsequent battery cycles (FIG. 2) shows that NbOC powder coated NMC622 electrodes effectively maintain their capacity, giving at least >92.5% of capacity retention after 80 cycles, while pristine electrode maintains only 84%.

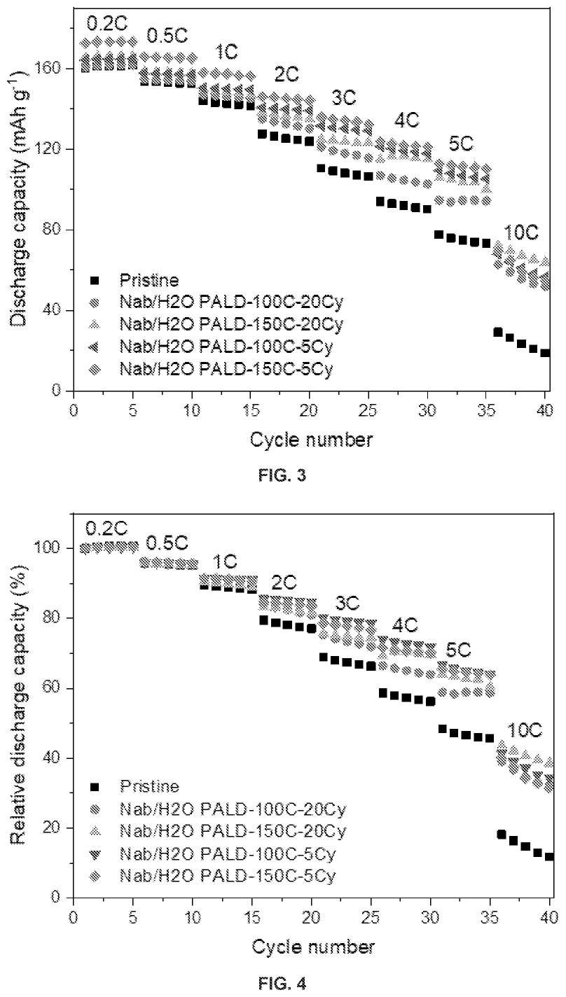

As shown in FIG. 3 and FIG. 4, when comparing C-rate performance, NbOC powder coated NMC622 electrodes have higher capacity at all ranges of C-rates (0.2 C to 10 C) compared to pristine electrodes, even for 20 ALD cycled samples. This improvement can be due to the Carbon doping effect, which may make the films more porous compared to other metal oxides thin films such as Al2O3, in which 10 ALD cycles is detrimental for battery performance (S.-H. Lee et al., U.S. Pat. No. 9,196,901 B2, 2012). The porosity may permit better Li+ ion transfer compared to a densified metal oxide film.

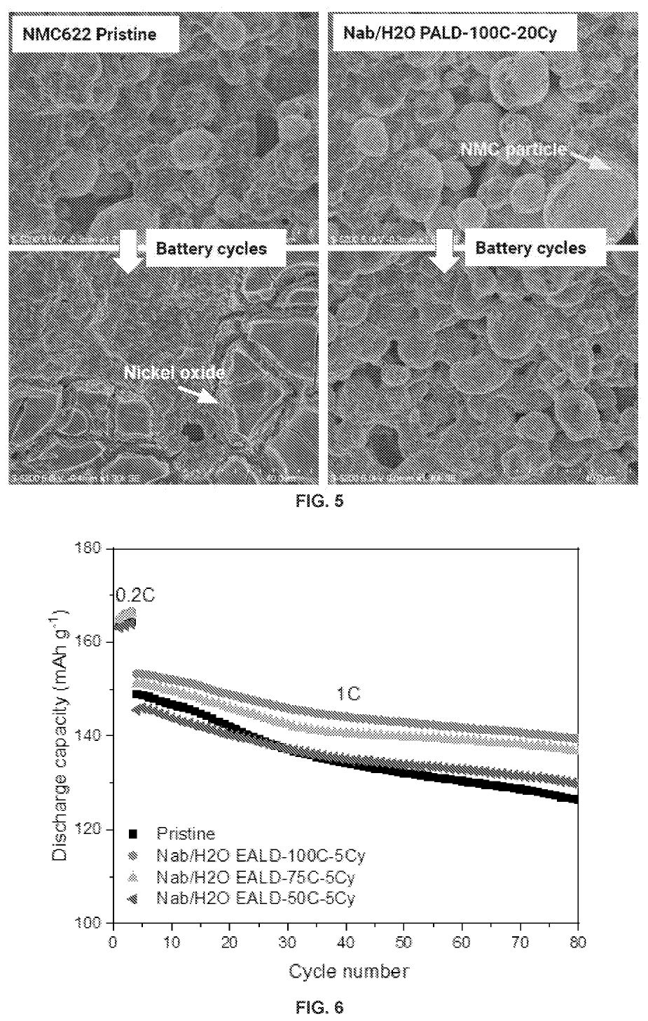

Based on the Scanning Electron Micrograph analyses shown in FIG. 5, the presence of the NbOC deposits/partial films allows the preservation of the material morphology while the pristine material tends to degrade, with the presence of NiOx distinct grains, which can result from the dissolution of nickel from NMC particles, then reposition on electrode surface. These image analyses correlate well with the improved electrochemical performance discussed above.

### Examples 6-9: Deposition and Electrochemical Performances of NbOC Thin Films Deposited on NMC622 Electrodes at 50, 75 and 100° C.

### Experimental Conditions for Deposit Formation:

Depositions were performed on NMC622 electrodes in a thermal ALD reactor in the following experimental conditions:
Reactor temperature x° C.
Reactor Pressure: 1 torr
Precursor canister T: 95° C.
Precursor canister P: 50 torr
Number of cycles: y

### Pulse Sequence:

Nb precursor: 30 s
Purge: 20 s
H₂O: 5 s
Purge: 5 s

The Nb precursor is NbCp(=NtBu)(NMe₂)₂ (“NAB”). The number of cycles on NMC622 electrodes or NMC powder are typically limited to 5-100 ALD cycles, corresponding to about 1.1 to 85 Å, a thickness insufficient to perform film composition. Such characterizations were therefore performed on films deposited after 300 ALD cycles. The corresponding thickness and film composition are:
process temperature: 100° C.⇒GPC˜0.23 Å. Nb: ˜17%, O˜40%, C˜42%, N<DL
process temperature: 75° C.⇒GPC˜0.28 Å. Nb: ˜20%, O˜45%, C˜34%, N<DL
process temperature: 50° C.⇒GPC˜0.85 Å. Nb: ˜16%, O˜35%, C˜48%, N<DL

The refractive index of these films is about 1.7, vs. 2.22 for Nb₂O₅ thin films at 275 C and above.

### Electrochemical Characterizations:

Experimental Conditions:
Cathode material NMC622
Electrode is composed of 88:7:5 wt % of active material:carbon black (C65):PVDF (Solef 5130), which is then casted on Al current corrector using a doctor blade (200 micron).
Five NbCp(=NtBu)(NMe2)2/H₂O ALD cycles at process temperatures provided in the graph
Electrolyte: 1M LiPFe in EC:EMC(1:1 wt)
Use of Li metal as anode material
Electrode loading of ˜5 mg/cm², 40 micron thick
1 C=180 mA g⁻¹, battery cycled between 3.0 and 4.3 V (vs Li⁺/Li)

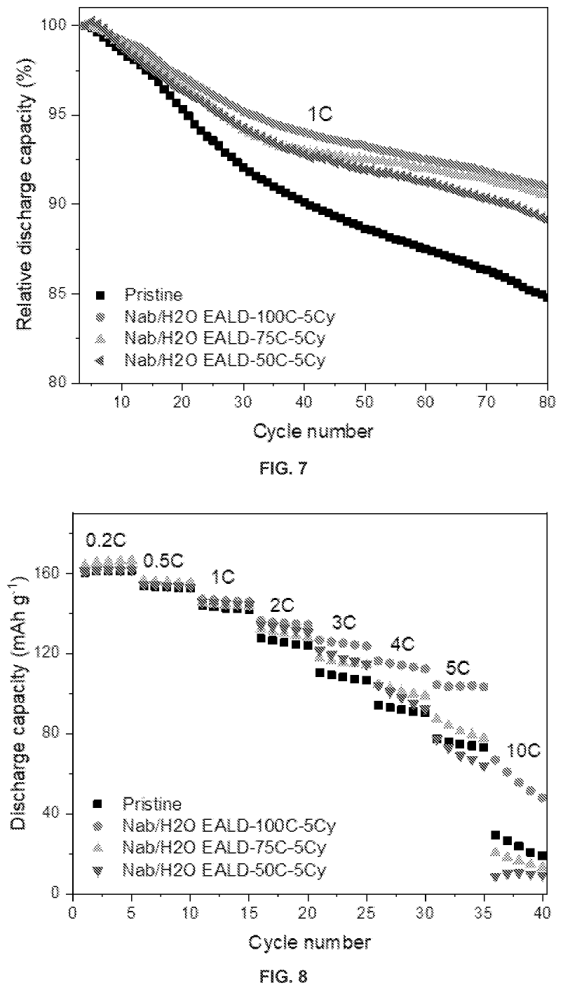

The long term cycle stability of NbOC thin film coated NMC622 electrodes (FIG. 6) shows not only higher discharge capacity at first cycle at 1 C (4th cycle) regardless of ALD temperature, demonstrating at least >92% of capacity retention after 80 battery cycles, while 84% of retention is observed for pristine NMC622 electrode (FIG. 7). Temperature dependence is also observed with ALD at 100° C. being the optimal temperature for better long term cycle stability under these conditions for this experimental battery.

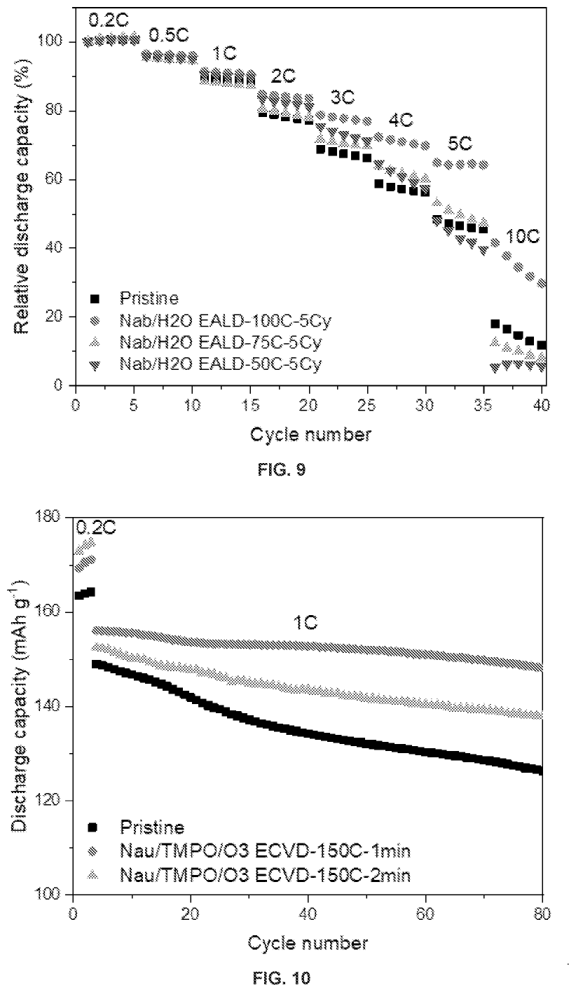

In terms of C-rate performance, NbOC thin films deposition on NMC622 electrodes enable them to give higher capacity at 0.2 C-5 C, compared to pristine electrodes (FIG. 8 and FIG. 9). At 10 C, only NbCp(=NtBu)(NMe2)2/H₂O electrode ALD performed at 100° C. shows higher capacity than a pristine electrode. As already demonstrated in the long term cycling test (FIG. 6), this C-rate result confirms again that the optimal ALD temperature is 100° C. in these experiments.

### Examples 10-13: Deposition and Electrochemical Performances of NbOC Thin Film Deposited on NMC622 Electrode at 75, 100, 125 and 150° C. Using Nb(═NtBu)(NMe₂)₂(OEt)/H₂O

Similar experiments were performed with the precursor Nb(═NtBu)(NMe₂)₂(OEt) (“NAU”) substituted for NAB. The resulting films had the following properties:
3-61 Å thick
Refractive index from 2.06 to 2.28
Atomic composition of 300 cycle films:
   process temperature: 150° C.⇒GPC˜0.66 Å. Nb: ˜25%, O˜60%, C˜11%, N˜2%
   process temperature: 125° C.⇒GPC˜1.69 Å. Nb: ˜30%, O˜64%, C˜4%, N˜1%
   process temperature: 100° C.⇒GPC˜2.25 Å. Nb: ˜27%, O˜57%, C˜14%, N˜1%
   process temperature: 75° C.⇒GPC˜3.07 Å. Nb: ˜25%, O˜58%, C˜15%, N˜2%

These electrodes had a similar improvement in electrochemical performance as the electrodes with NAB derived films.

### Examples 14-15: Chemical Vapor Deposition and Electrochemical Performances of NbOCP Thin Films Deposited on NMC622 Electrodes

NbOCP deposit was performed according to the following experimental conditions:

### Deposition Conditions and Characterizations:

Reactor temperature 100-150° C.
Reactor Pressure: 1 torr
Nb precursor canister T: 95° C.
Nb precursor canister P: 10 torr
Nb precursor bubbling FR: 50 sccm
TMPO canister T: 30° C.
TMPO canister P: 10 torr
TMPO bubbling FR: 50 sccm
Reaction time: y min (specified in the graph)

### Precursor Flow Rates:

Nb precursor: 5 sccm
TMPO: 5 sccm
O₃: 100 sccm

The niobium precursor is Nb(═NtBu)(NMe₂)₂(OEt). The corresponding thickness and film composition at 100° C. are t˜2.1 nm. Nb: 29.6%, O: 58.0%, C7.8%, P: 2.6%, N<DL; at 150° C., t˜1.8 nm. Nb: 24.3˜%, O: 60.1˜%, C: 7.6˜%, P: 6.4%, N<DL.

### Electrochemical Characterizations:

Cathode material NMC622
Electrode is composed of 88:7:5 wt % of active material:carbon black (C65):PVDF (Solef 5130), which is then casted on Al current corrector using doctor blade (200 micron).
NbOP deposited by electrode CVD using:
CVD process temperature=100-150° C.; duration: 1 and 2 min
Electrolyte: 1M LiPFe in EC:EMC(1:1 wt)
Use of Li metal as anode material
Electrode loading of ˜5 mg/cm², 40 um of thickness
1 C=180 mA g⁻¹, battery cycled between 3.0 and 4.3 V (vs Li⁺/Li)

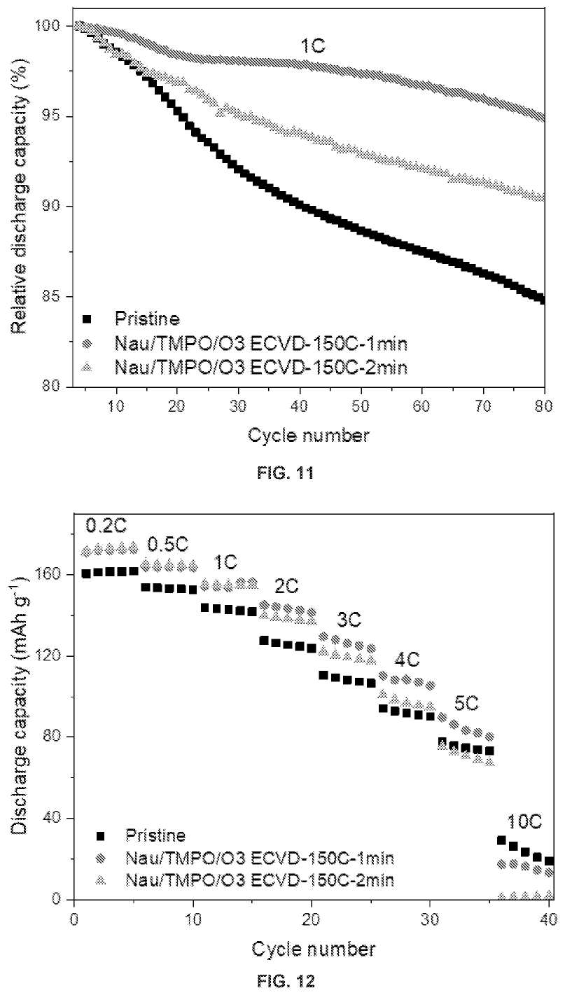

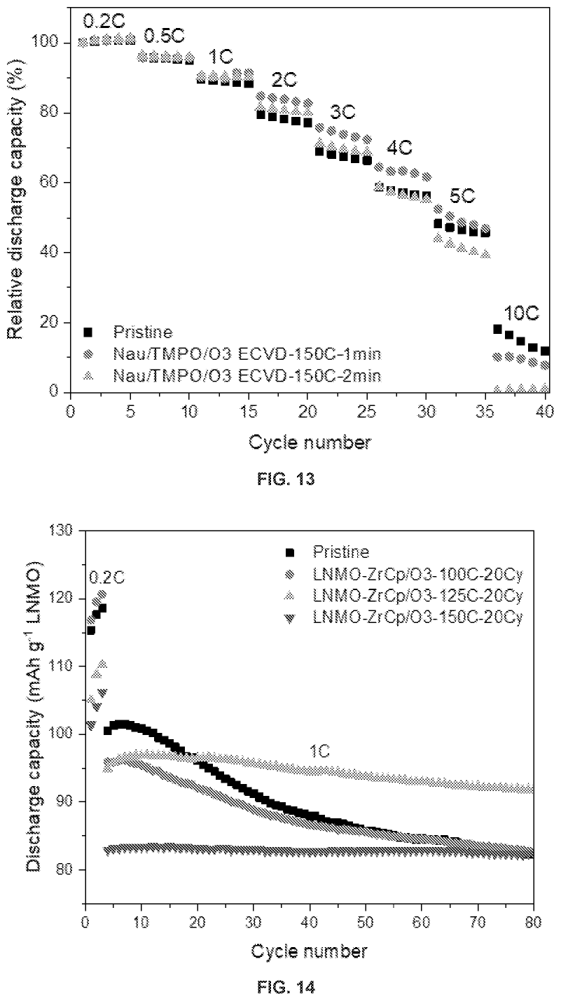

As shown in FIG. 10 and FIG. 11, the initial capacity at 0.2 C for NbOCP thin films coated NMC622 electrodes increased compared to a pristine NMC622 electrode. For subsequent cycles, NbOCP thin films coated NMC622 electrodes show obviously better cycling performance, maintaining >95% of retention after 80 battery cycles at 1 C for Nb(═NtBu)(NMe2)2(OEt)/TMPO/O3 ECVD-150° C.-1 min electrode. NMC622 electrodes with NbOCP thin films show higher capacity at low and moderate C-rate until 5 C, compared to pristine a NMC622 electrode (FIG. 12 and FIG. 13).

### Examples 16-19: Deposition and Electrochemical Performances of ZrOC Thin Films Deposited on LNMO Electrodes

### Deposition Conditions and Characterizations:

Reactor temperature 75-150° C.
Reactor Pressure: 1 torr
Zr precursor canister T: 100° C.
Zr precursor canister P: 20 torr
Zr precursor bubbling FR: 40 sccm
Reaction time: y min (specified in the graph)

### Precursor Flow Rates:

Zr precursor: 2 sccm
O₃: 100 sccm

### Pulse Sequence:

Zr precursor: 20 s
Purge: 5 s
O₃: 5 s
Purge: 5 s

The Zirconium precursor is ZrCp(NMe₂)₃ and may be noted “ZrCp”. The average film thickness was approximately 2 to 20 Å. The films contained about 20%-25% Zr, about 1% to 5% Nitrogen, about 40%-60% Oxygen and about 12-30% C. The refractive index was 1.92 at 75 degrees C. up to 2.15 at 150 degrees C. (compared to 2.21 for ZrO₂).

### Electrochemical Characterizations:

Cathode material LNMO
ZrOC deposited by electrode by CVD using: process temperature=50 to 150° C.; duration: 5-50 cycles
Electrolyte: 1M LiPF₆ in EC:EMC(1:1 wt)
Use of Li metal as anode
˜5 mg/cm² loading, 40 um of thickness

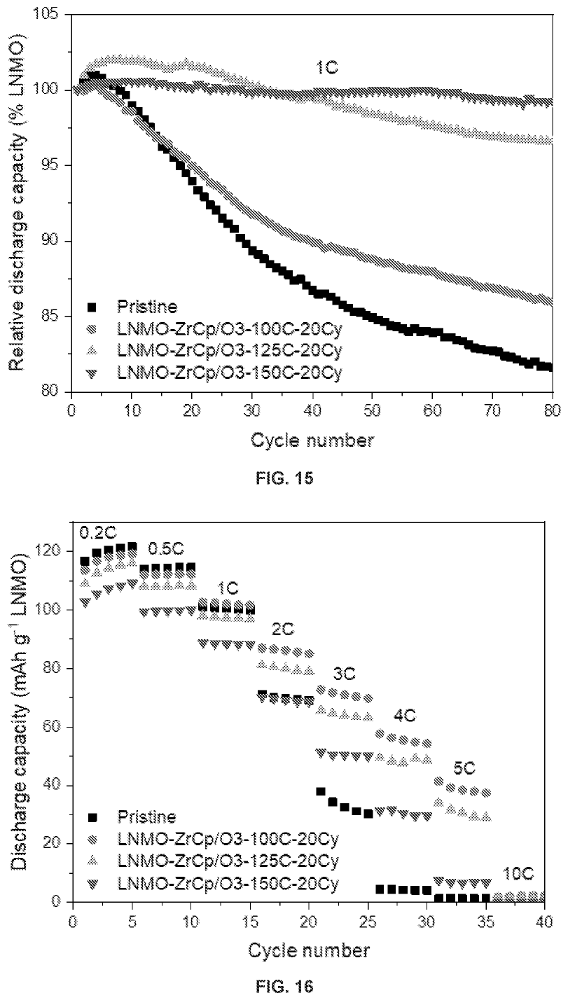

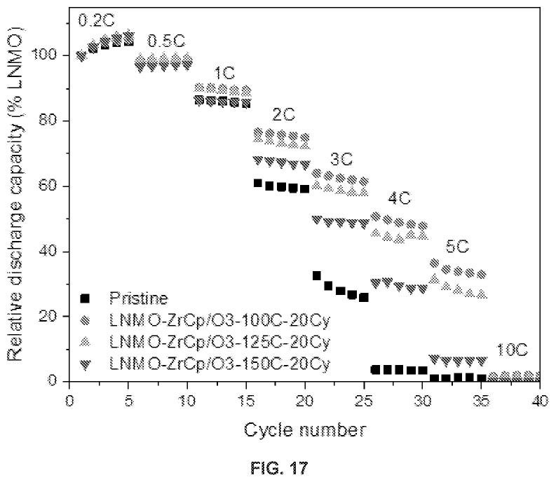

As shown in FIG. 14 and FIG. 15, the initial capacity at 0.2 C for ZrOC thin films coated LNMO electrodes slightly decreased compared to a pristine NMC622 electrode as ALD temperature increased, due to dense ALD coating film. For subsequent cycles, ZrOC thin films coated LNMO electrodes show obviously better cycling performance, especially for ZrCp/O3-125 C-20Cy and ZrCp/O3-150 C-20Cy, which maintained 97% and 100% of retention after 80 battery cycles at 1 C, respectively, while 82% of capacity retention was observed for the pristine LNMO electrode. LNMO electrodes with ZrOC thin films show higher capacity at low and moderate C-rate until SC, compared to pristine a NMC622 electrode (FIG. 16 and FIG. 17), while no apparent capacity was observed for both the pristine and ZrOC thin films coated LNMO electrodes.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties; as well as for the specific information for which each is cited.

1. A cathode or a cathode active material comprising at least a partial surface coating of a doped metal oxide film, preferably the metal is selected from Niobium, Tantalum, Vanadium, Zirconium, Titanium, Hafnium, Tungsten, Molybdenum, Chromium and combinations thereof.

2. The cathode or a cathode active material of claim 1, wherein the doped metal oxide film is either a metal, oxygen and carbon-containing film or a metal, oxygen and phosphorus containing film.

3. The cathode or a cathode active material of claim 1, wherein the doped metal oxide film is a doped Niobium oxide film.

4. The cathode or a cathode active material of claim 1, wherein the doped metal oxide film is a Niobium, oxygen and carbon-containing film or a Niobium, oxygen and phosphorus containing film.

5. The cathode or a cathode active material of claim 1, wherein the cathode or a cathode active material is only partially coated with the doped metal oxide film.

6. The cathode or a cathode active material of claim 1, wherein the doped metal oxide film has an average thickness of 0.02 nm to 10 nm.

7. The cathode or a cathode active material of claim 1, wherein the doped metal oxide film has an atomic percentage for carbon atoms from 5% to 50%.

8. The cathode or a cathode active material of claim 3, wherein the doped metal oxide film has a refractive index of 1.5 to 2.5.

9. The cathode or a cathode active material of claim 1, wherein the doped metal oxide has an average atomic composition of MxO_{y}D_{z}, wherein M is a transition metal or a II-A to VI-B element, O is oxygen, and D is a dopant atom other than lithium, M or O, preferably D is selected from C, Si, Sn, B, Al, N, P, or S, and wherein x=10 to 60%, y ranges from 10 to 60%, and z ranges from 5 to 50%, preferably from 10 to 30%.

10. The cathode or a cathode active material of claim 9, wherein the cathode or a cathode active material is only partially coated with the doped metal oxide film.

11. The cathode or a cathode active material of claim 9, wherein the doped metal oxide film has an average thickness of 0.02 nm to 10 nm.

12. The cathode or a cathode active material of claim 9, wherein the doped metal oxide film has an atomic percentage for carbon atoms from 5% to 50%.

13. The cathode or a cathode active material of claim 9, wherein the doped metal oxide film has a refractive index of 1.5 to 2.5.

14. A proton exchange membrane battery comprising a cathode or cathode active material according to claim 1.

15. A method of coating a cathode or a cathode active material with a doped metal oxide film, the method comprising the steps of:
a1. exposing the cathode or cathode active material to a chemical precursor vapor, and
b1. depositing the doped metal oxide film on the cathode or cathode active material.

16. The method of claim 15, further comprising a step a2. of exposing the cathode or cathode active material to a co-reactant.

17. The method of claim 16, wherein the step a1. of exposing the cathode or cathode active material to a chemical precursor vapor and the step a2. of exposing the cathode or cathode active material to a co-reactant, are sequentially performed.

18. The method of claim 17, further comprising a step a1i. of purging the chemical precursor vapor prior to step a2. of exposing the cathode or cathode active material to a co-reactant.

19. The method of claim 18, wherein the step b1. depositing the doped metal oxide film on the cathode or cathode active material comprises an atomic layer deposition step.

20. The method of claim 18, wherein the step b1. of depositing the doped metal oxide film on the cathode or cathode active material comprises a chemical vapor deposition step.

21. The method of claim 15, wherein the co-reactant is an oxygen source such as O2, O3, H2O, H2O2, NO, NO2, N2O or a NOx; an oxygen-containing silicon precursor, an oxygen-containing tin precursor, a phosphate, or a sulfate.

22. The method of claim 15, wherein the doped metal oxide film produced by step b1. has an average atomic composition of MₓO_{y}D_{z}, wherein M is a transition metal or a II-A to VI-B element, preferably M is selected from Niobium, Tantalum, Vanadium, Tungsten, Molybdenum, Chromium, Hafnium, Zirconium, Titanium, and combinations thereof, O is oxygen, and D is a dopant atom other than lithium, M or O, preferably D is selected from C, Si, Sn, B, Al, N, P, or S, and wherein x=0.1-0.3, y=0.3-0.65 and z=0.1-0.3.

23. The method of claim 15, wherein one or more of steps are repeated.

24. The method of claim 15, wherein a temperature of the chemical precursor vapor and/or the cathode or cathode active material is 200 degrees C. or less.

25. The method of claim 15, wherein the cathode active material, or the cathode active material in the cathode, is selected from the group consisting of a) layered oxides such as Ni-rich cathode materials like NMC (lithium nickel manganese cobalt oxide) and NCA (lithium nickel cobalt aluminum oxide); b) spinel cathode materials such as LMO (lithium manganese oxide), LNMO (lithium nickel manganese oxide); c) Olivine structured cathode materials, in particular the family of Olivine phosphates such as LCP (lithium cobalt phosphate), LNP (lithium nickel phosphate); and combinations thereof.
